(19) United States
(12) Patent Application Publication
(10) Pub. No.: US 2004/0068444 A1
(43) Pub. Date: Apr. 8, 2004

(54) Method and system for applying part number

(76) Inventors: Chih-Hung Chien, Taipei (TW); Li-Chuan Yu, Taipei (TW); Li-Hua Lee, Taipei (TW); Hui-Min Chien, Taipei (TW); Sai-Wing Young, Taipei (TW); Chiu-Chun Chen, Taipei (TW)

Correspondence Address: BIRCH STEWART KOLASCH & BIRCH, PO BOX 747, FALLS CHURCH, VA, 22040-0747, US

(21) Appl. No.: 10/387,529

(22) Filed: Mar. 14, 2003

(30) Foreign Application Priority Data
Oct. 7, 2002 (TW) 91123070

(51) Int. Cl. G06F 17/60; G06F 7/00; G06F 17/30

(52) U.S. Cl. 705/26; 707/3

(57) ABSTRACT

A method and a system for applying a part number are provided, for allowing a user to apply a part number through a network terminal device via a network communication system, with data relevant to part number application being stored in a database. First, a form search module searches a part-number application form from the database according to operation conditions input by the user for allowing the user to input data for applying a part number. A data comparison module determines if this part number already exists or is currently being applied by another user; if yes, the data comparison module provides relevant data to this part number as a reference for the user who intends to apply the part number; otherwise, a data verification module transmits the part-number application form to examination units for verification. Finally, a data storage module stores the examined part-number application form in the database.

### FIELD OF THE INVENTION

The present invention relates to part number applying methods and systems, and more particularly, to a method and a system for applying a part number, for allowing a user at a terminal device to apply a variety of part numbers via a network communication system.

### BACKGROUND OF THE INVENTION

With advance in science and technology, as well as wide application of technologies in electronics, information, and automation, a huge step is gained for developing production technology. As the market gets more and more competitive, the whole society is driven by such competition to move forwards swiftly, creating a harsh environment for an industry to survive. Therefore, the industry needs to develop within the shortest time a product that satisfies the market demand without spending too much capital. Basically, a development cost is directly proportional to development time. And more investment is involved as the development duration gets longer. So, the industry is driven by this factor towards shortening period of developing the product by all means. Since industries from all over the world are facing serious challenges of shortening the developing time for more complicated product in order to occupy the market and reduce the product cost. It has become a common goal for industry to adapt to the fast changing market demand, and to survive and thrive among competitions using strategies, such as high quality, low cost, fast development of new product, and so on.

Since the product is usually made up of many components, a lot of time is spent for personnel from different industrial departments to search data related to the product. It has become an important subject to specifically describe inter-relationship between all product data, such that the relationship among the components is clearly understood. And in order to meet the actual demand by modifying or adding all component materials especially during design and production processes, personnel from the design, research and development (RD), and production departments need to submit a part number request form (PNRF) for the component materials. The PNRF includes contents such as product identity code, application date, material categories, material forms, estimated price, person in charge of part number data center, examination date, purchase specification footnote, manufacturing company information footnote, and so on. After the PNRF is completed, it is examined by different industrial intra-examination units before providing a part number for new component material required by the applicant. In the actual production, the modifications occur very often. For example, a modification for the certain component may cause modification for the related component. Alternatively, the appropriate modification is also required if the component is shared with other products. While the modifications cause chaos in arrangement of the product data, these documents may be saved in a document server or several document servers that are located at different places. The data processing may get complicated when the product data is not properly managed. For instance, some key data may be stored at several places, making the search more complex and troublesome. And when the data is acquired from one place to another, the data is usually modified, making it difficult to keep data uniform. Therefore, this complex relationship usually causes chaos and loss that can not be compensated.

While most of industrial data is mainly transmitted in the form of paper document, report, and telephone communication, upstream RD departments are unable to exchange and share data with the downstream departments in time. As all departments are unable to understand variations in the RD process in time, a long RD period for the product is resulted. Thus, the industrial organization should adopt an effective strategy to keep track of the progress for designing and producing the entire product. And this objective is achieved by adopting computer aided technique (CAT), which strengthens the product RD process. However, this introduces other new problems. Even though the product RD process is computerized at certain degree by adopting computer-aided tools in the industrial organization, management in the form of paper document is still required. Thus, without an efficient file management, the available design resource is not used effectively.

There is a long history for the product data. At the early carpenter manufacturing age, design process and manufacturing process are integrated and completed solely by individual. As cooperative negotiation is considered not important at that time, expression and exchange of the product related data are neglected. By relying mainly on experience and skill, the manufacturing process and method are not completely jotted down, with certain key parts being omitted on purpose. So, the data is not expressed thoroughly. With an increasing scientific improvement and social demand in near generation, a major industrialization generation is introduced as a result of a swift development in manufacturing industry, followed by a major change in expression and management of product data. And as the manufacturing industry continues to develop, a variety of advanced technologies are adopted to shorten period for developing the industrial product, but the message amount still keeps multiplied. This implies that the data stands a very important place in the industry.

Even though the industry has gradually computerized information, indicating industry improvement and development, the most efficient way of applying information is to achieve the industrial goal. The information is established from the industry as a new industrial resource whose usage and management becomes a new task for the industrial information. However, a majority of the industrial computer aided tools are discrete and isolated systems that are non-compatible software for producing different data formats. Also these computer aided tools include different storage media and are managed by different personnel. As a result, the data can not be transmitted and shared efficiently when the design, technical, and manufacturing departments are managed. And for the same reason, the data can not be transmitted and shared efficiently between the related industries or even between the industry and trade. A more advanced method should be adopted by the industry to manage and negotiate for development of the entire product until it is manufactured. Furthermore, any two application software must not directly share or exchange product data during the process of designing the product. At present, there are almost one quarter to one third of design and management technicians who are not concentrated with their essential jobs daily, but stuck in meeting, discussion, waiting or managing for the data instead. Since such designing and manufacturing process lacks of uniform management of product data, product operation time and manufacturing cost are increased as a result. Therefore, the industry nowadays has to face problem as to how to respond a huge change in product data in order to adjust expression and management of the product data.

### SUMMARY OF THE INVENTION

In order to solve the above-mentioned problems faced by the conventional art, an objective of the present invention is to provide a method and a system for applying a part number, so as to collectively manage product data resource and user authority. As a result, users from industrial organizations distributed at different locations may execute application and search for the part number automatically via the network communication system.

Another objective of the present invention is to provide a method and a system for applying a part number, whereby standardization of the part number application forms for all departments is met, standard components are chosen, and design request is met with lowest cost, so as to produce the most product variety with the least number of component parts.

A further objective of the present invention is to provide a method and a system for applying a part number, allowing the user to retrieve accurate and complete information in time, as well as shortening time for searching and applying the part number.

And yet another objective of the present invention is to provide a method and a system for applying a part number, whereby modification history of the part number is kept, so that a modification command and data part number that are once executed may be searched using relation navigation function of the database when the user wishes to search relative part number application and modification process.

As embodied and broadly described herein, the invention provides a system for applying a part number, the system comprises of a network server system for linking the system for applying the part number to the network terminal device via a network communication system; a database for storing the part number application form data and relative data required for applying the part number; a form search module for searching the corresponding the electronic form data in the database and synthesizing the electronic form page in the network terminal device according to the operation commands input by the user; a data comparison module for searching the key message from the part number application forms input by the user, and locating the part number application related data that corresponds to the key message in the database; a data-verification module for transmitting the part number application form completed by the user to each examination units; and a data storage module for storing the examined part number application related data in the database.

According to the system for applying part number, the form search module searches the corresponding form page in the database according to the operation conditions input by the user when the part number is applied online. Next, the data comparison module searches the key message from the part number application form data input by the user via the network terminal device, and locates any data related to the key message in the database, so as to remind the user whether the part number to be applied is already available or is currently applied by another user. If it is, the relative data is provided to the user as a reference. Otherwise, the data verification module transmits the part number application form completed by the user to each examination unit for searching and examining the relative data, so as to determine if a new part number is given. Finally, the data storage module stores the examined part number application form related data in the database.

With the method and system for applying a part number, the user can conduct an online search for details of a variety of part numbers using a network terminal device via the network communication system. Also, the part number application form can be filled in and verified directly with the method and system of the present invention. As a result, the available part number can be quickly located to avoid wasting time and data spent on repeat application of the same part number. On the other hand, the part number can be quickly applied by those actually in urgent need. And as the data is transmitted in the form of electronic data, the data can be transmitted to those in need anytime within the permitted authority, achieving the goal of data exchange and sharing.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating a basic setup of a system for applying part number according to the present invention; and

FIG. 2 is a flow chart illustrating application of a raw material part number using the method of applying the part number according to the present invention.

### DETAILED DESCRIPTION OF THE PREFERRED EMBODIMENTS

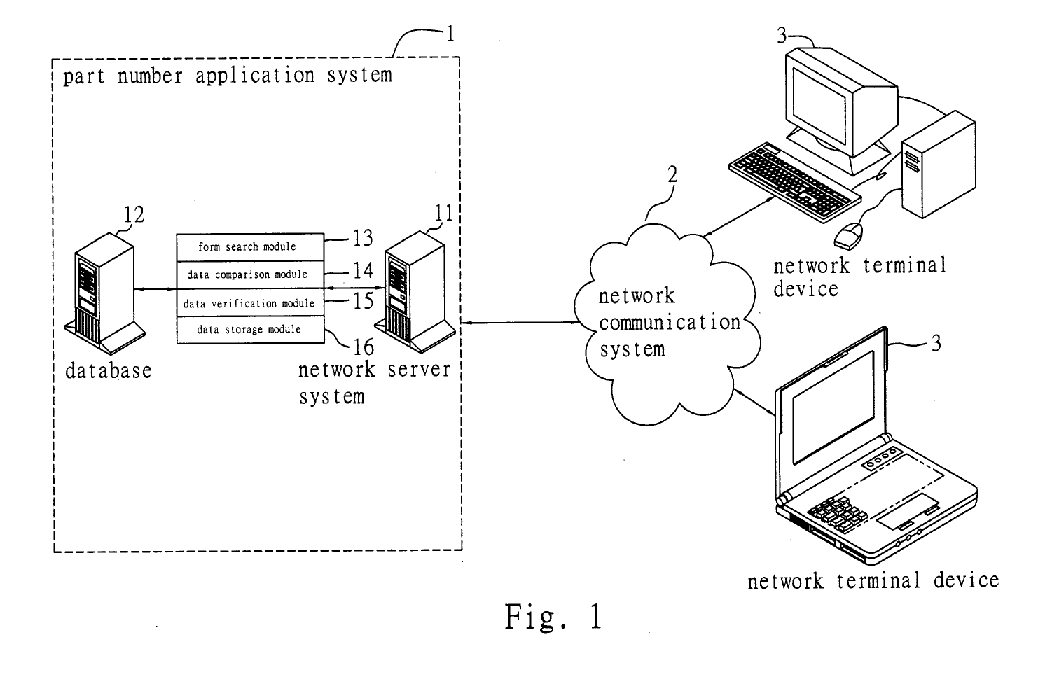

FIG. 1 is a block diagram illustrating a basic setup of a system for applying part number according to the present invention. The system for applying part number 1 enables a user to operate on a browser of network terminal device 3 via a network communication system 2, wherein the network communication system 2 may be Internet, Intranet, or Extranet for linking the system for applying part number 1 to the network terminal device 3. The system for applying part number 1 is linked via the network communication system 2 to the network terminal device 3 to transmit data, wherein the network terminal device 3 may be personal computer (PC), or notebook (NB). And since the structure setup of the network communication system 2 is well known to one skilled in the art, the detail thereof is omitted herein.

The system for applying part number 1 comprises at least a network server system 11, a database 12, a form-synthesizing module 13, a data comparison module 14, a data-verification module 15, and a data storage module 16.

The network server system 11 links the system for applying part number 1 to the network communication system 3 via the network communication system 2 and to respond the users' commands or other needs for the network terminal device 3, so as to access data. In this embodiment, the network terminal device 3 is linked to the system for applying part number 1 using the web browser (such as Microsoft Internet Explorer or Netscape Navigator) in the network terminal device 3 via the network communication system 2 and the network server system 11.

The database 12 enables the system for applying part number 1 to store a variety of part number application form data, to provide industrial departments with part numbers to be applied according to production stages, and to store data that corresponds to the part number applications, including data such as material classifications, part number examination date, purchase specification, and manufacturing company data footnote, and so on. And in order to provide a complete description of the product, component, and spare part within the lifetime of the product, forms related to the product, component, and spare part are integrated to establish a document catalogue of complete part number descriptions, known also as a document collection or document folder. Then, the document catalogue is stored in the database 12, so that the document collection or documents in the collection can be searched.

With the operation commands input via the network terminal device 3 by the user, the form-synthesizing module 13 searches the corresponding part number application electronic form page from the database 12. And a prepared part number list is provided for each unit, such that the user can input via the network terminal device 3 based on each column of the electronic form the part number application data to be matched or processed.

And the data matching module 14 searches key message, such as type of part number to be applied, from the part number application form data input via the network terminal device 3 by the user, and searches from the database for any part number application related data that corresponds to the key message. The data in the part number application form may serve as an attribute, such as the key word that facilitates the user to quickly find the corresponding form in the search. And with the key words, data of the same category can be classified and recorded.

The data-verification module 15 transmits the part number application form completed by the user to the examination unit for examination. And when the part number application form is transmitted, the data verification module 15 may transmit the part number application form in sequence or synchronously to all examination units for verification according to the application form categories.

And after the examination, the data storage module 16 stores the examined part number application form related data in the database. Meanwhile, the data storage module 16 may keep the modification history of the part number version. That is, if one product is partially modified, the history record for modifying the structure of the product is saved in the database 12, so that when the user wishes to search the application and modification process for the related part number, the modification commands once executed or data part number may be located using relative navigation function of the database 12. And without such function, the data related to detail modification may be lost during the filing process in the industry organization. As a result, the old part number data required for changing part number material in the future may be deleted after being analyzed as being not useful. Thus, this affects manufacturing process of the whole product.

With the system for applying part number 1 described above, steps for applying the new part number are described below.

In the present embodiment, before a research and development (RD) engineer in an industrial organization applies part number for raw material in the system for applying part number 1 via the network communication system 2, he/she needs to input user name, account name, and password using the network terminal device 3 to make sure the user has the operation authority. After that, via the network terminal device 3, the system for applying part number 1 displays a function menu web page where the user carries out the operation. Then, based on the operation commands input by the user, the form search module searches from the database 12 for the corresponding part number application form page for the raw material, which page is displayed in the network terminal device 3, where the user can input the data for searching and applying the part number. The data in this case includes product identity codes, material categories, material classification codes, and so on.

Next, the data comparison module 14 searches a key message, such as material categories or material classification codes from the raw material part number application form data. As a result, the database 12 is searched for any part number application related data that corresponds to the key message, so as to remind the user whether the material to be applied is already available or currently applied by other users. If it is, the part number data for the material that similar or identical to that to be applied by the user is provided to the user for reference. Otherwise, after the confirmed part number application form is received, the data verification module 15 transmits the part number application form via the network communication system 2 to the network terminal devices of the examination and assessment units, such as Engineering Project Engineer (EPE) department and Component Engineer (CE) department for verification and examination.

Once each examination unit receives the raw material part number application form, a search command may be input via the network terminal device according to the required material type and the purpose thereof in the part number application form. Therefore, based on the search conditions input by the user in examination unit, the data matching module 14 searches the database 12 for part number application data related to the search conditions and displays the data in the network terminal device 3, enabling a comparison be made between the part number application data and the part number data available in the database 12. So, whether the RD department needs a new material part number or a replacement with the available material can be determined.

Then, the EPE and CE departments respond to the part number application document submitted by the RD department, whereby an examination status is input in the part number application document based on the search result of examination unit. If the examination unit finds the replacement with the available material in the database 12, a “rejection” selection is input in the examination column of the part number application form using the network terminal device 3. And the part number application form and relative reference data searched by the examination unit are sent back to the RD department as the reference to be browsed of. However, if the examination unit feels a new material part number is needed, a “pass” selection is input in the column of the part number application form using the network terminal device 3, and a new part number is provided according to the part number application form. The relative data of the examined part number application form is then saved in the database 12 by the data storage module 16, while the data verification module 15 sends the part number application form back to the RD department to complete part number application and addition processes.

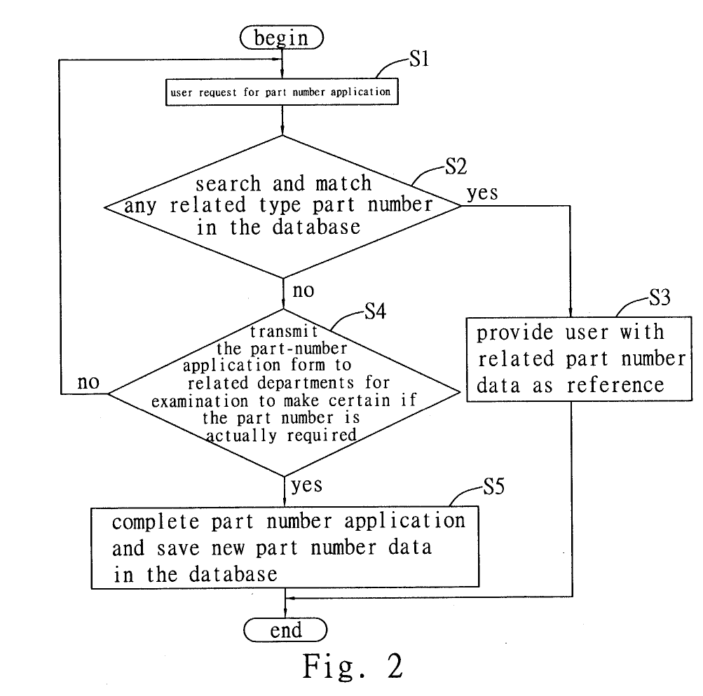

Referring to FIG. 2, the method of applying the part number according to the present invention is illustrated in the flow chart. The system for applying part number 1 is linked to the network terminal device 3 via the network communication system 2. The system for applying part number 1 also provides the network server system 11 for accessing data with the network terminal device 3, saves with at least a variety of part number application form data, provides different industrial departments with types of part numbers required at different production stages, and saves with relative data that corresponds to the part number application. For example, data such as the material categories, part number verification date, purchase specification, manufacturing company footnote, and so on are included in the database 12. Then, the process moves on to step S1.

In step S1, according to the operation commands input by the user, the form search module 13 searches the corresponding form page from the database 12 and displays the page in the network terminal device 3 where the user can input part number application data. Next, the process moves on to step S2.

In step S2, the data comparison module 14 searches the key message from the raw material part number application form data input by the user via the network terminal device. As a result, the database 12 is searched for the part number application related data that corresponds to the key message, so as to remind the user whether the material to be applied is already available or currently applied by other users. If it is, the process moves on to step S3. Otherwise, the process moves on to step S4.

In step S3, the data comparison module 14 provides the user with the part number related data for the available material as a reference.

In step S4, the data verification module 15 transmits the part number application form completed by the user to examination unit for verification, so as to determine if part number re-application is actually required. If it is, the process moves on to step S5. Otherwise, the process moves back to step S1.

In step S5, the data storage module 16 saves data related to the examined part number application form in the database 12, and the part number application form is sent back by the data verification module 15 to the applicant in order to complete part number application and addition processes.

Summarizing from the above, the present invention provides an part number application method and system for the same, whereby the user can conduct an instant online search for the part number details via the network communication system. Also, with the application method and system for the same, the part number application form can be filled and verified directly, so that the available type of part number can be searched quickly to prevent repetitive application for the identical part number and reduce wasting of time and data. On the other hand, applicant with urgent need may be provided with the part number required for quick application. And since the data transmitted in the form of electronic data, the data may be transmitted to those in needs anytime with permitted authority, achieving data exchange and sharing.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for applying a part number, for allowing a user to apply and search a part number through a network terminal device via a network communication system, with data relevant to part number application being stored in a database, the method comprising:
searching via a form search module a part-number application form from the database according to operation conditions input by the user via the network terminal device and displaying the part-number application form in the network terminal device for allowing the user to input data for applying a part number thereto;
determining via a data comparison module a key message of the part number from the data input by the user to the part-number application form, and searching data from the database relating to the key message to determine if the part number to be applied by the user already exists or is currently being applied by another user; if yes, providing via the data comparison module relevant data to this part number as a reference for the user who intends to apply the part number; otherwise, transmitting via a data verification module the part-number application form with the input data from the user to associated examination units for data search and examination; and
storing via a data storage module the examined part-number application form in the database.

2. The method of claim 1, wherein the data storage module stores history data for version modification of a part number in the database as a reference for later search by the user.

3. The method of claim 1, wherein the network terminal device is a computer.

4. The method of claim 1, wherein the network communication system is selected from the group consisting of Internet, an intranet, and an extranet.

5. A system for applying a part number, for allowing a user to apply and search a part number through a network terminal device via a network communication system, the system comprising:
a network server system for linking the system for applying a part number to the network terminal device via the network communication system and allowing the network terminal device to respond to commands and requirements from the user for data access;
a database for storing a plurality of part-number application forms to allow various part numbers to be applied according to production requirements, and for storing data relevant to application of the part numbers;
a form search module for searching a web page of an electronic part-number application form from the database according to operation commands input by the user via the network terminal device, so as to allow the user to input data for applying a part number to columns of the electronic form via the network terminal device;
a data comparison module for determining a key message of the part number form the data input by the user and searching data from the database relating to the key message;
a data verification module for transmitting the part-number application form with the input data from the user to associated examination units for verification, wherein part-number application forms are transmitted in sequence or synchronously to the examination units for verification; and
a data storage module for storing the examined part-number application form in the database.

6. The system of claim 5, wherein the data storage module stores history data for version modification of a part number in the database as a reference for later search by the user.

7. The system of claim 5, wherein the network terminal device is a computer.

8. The system of claim 5, wherein the network communication system is selected from the group consisting of Internet, an intranet, and an extranet.
